(19) United States
(12) Patent Application Publication
(10) Pub. No.: US 2013/0146211 A1
(43) Pub. Date: Jun. 13, 2013

(54) PROCESS FOR PREPARING AN APPARATUS COMPRISING A GEL LAYER

(71) Applicant: TECHNOGEL ITALIA SRL, Pozzoleone (Vicenza) (IT)

(72) Inventors: MATTEO MASON, Limena (PD) (IT); MASSIMO LOSIO, Asolo (TV) (IT)

(73) Assignee: TECHNOGEL ITALIA SRL, Pozzoleone (Vicenza) (IT)

(21) Appl. No.: 13/762,865

(22) Filed: Feb. 8, 2013

Related U.S. Application Data
(63) Continuation-in-part of application No. 11/739,280, filed on Apr. 24, 2007, now abandoned.
(60) Provisional application No. 60/745,564, filed on Apr. 25, 2006.

(51) Int. Cl. B32B 5/18

(52) U.S. Cl. CPC B32B 5/18
USPC 156/93; 156/242

(57) ABSTRACT

A method for preparing a support apparatus including a gel layer and a second layer, such as a foam layer is provided. In particular, the invention provides a method for making a mattress. The method generally includes preparing a gel layer and affixing the gel layer to a second layer. In certain embodiments, where a foam layer is used as the second layer, the foam layer may have a surface having a cavity formed therein for receiving the gel layer.

### CROSS-REFERENCE TO RELATED APPLICATIONS

The present application is a continuation-in-part of application Ser. No. 11/739,280, filed Apr. 24, 2007, which claims priority to U.S. Provisional Patent Application No. 60/745,564, filed Apr. 25, 2006, both of the disclosures of which are incorporated by reference in their entireties.

### TECHNICAL FIELD

The present invention is generally directed to a method of preparing apparatuses designed for bodily support. In particular, the invention is directed to a method of preparing apparatuses comprising a gel layer and an additional layer, such as a foam layer.

### DESCRIPTION OF RELATED ART

Multiple apparatuses are known in the art for providing support to the body of a user. Such apparatuses generally comprise one or more layers of padding or cushioning to provide functional support of the user's body and to provide such support while also providing a level of comfort. Similarly, such apparatuses may also comprise mechanical supports, such as coil springs.

Advances in the art are generally directed to apparatuses that provide the functional support necessary in such apparatuses but also provide increased comfort or provide a decrease in the volume of materials necessary to provide the support. For example, U.S. Pat. No. 6,701,556 to Romano et al. discloses mattress or cushion structures designed to improve pressure distribution while reducing the overall thickness of the mattress or cushion. Further, U.S. Pat. No. 6,804,848 to Rose discloses an air support sleep system having an upper mattress air posturizing module and an adjustable air posturizing sleep surface.

While the apparatuses commonly used for bodily support may provide functional support, they yet fail to provide a level of comfort useful for facilitating restfulness or sleep, or for providing a greatest relief of pressure for the body parts in contact with the support surface. Gel materials are generally known to provide good physical comfort and pressure relief. Further, gels are also known to exhibit a relatively high thermal conductivity. Accordingly, gels, such as polyurethane gels, are generally regarded as having a “cool” feel to the body, as body heat is perceptibly moved away from the body when in contact with the gel.

In light of the desirable properties afforded by gel materials, it is not surprising that demand for support apparatuses comprising gels continues to increase. However, there has heretofore yet not been provided a method for preparing support apparatuses comprising a gel layer in a manner that is both cost effective and efficient.

Accordingly, there still remains a need in the field for methods of preparing apparatuses useful for bodily support that comprise a gel layer. Such methods are provided by the present invention.

### SUMMARY OF THE INVENTION

The present invention provides a method for preparing a support apparatus, such as a mattress. The apparatus prepared according to the invention comprises a gel layer. In further embodiments, the apparatus comprises a gel layer in combination with a foam layer. The inventive method provides for preparation of a variety of support apparatuses and finds particular use in the preparation of mattresses.

In one embodiment, the invention is directed to a method for preparing a support apparatus, such as a mattress, that comprises a gel layer and a cover layer. A method generally comprises the following steps: providing a mold; inserting a gel material into the mold to form the gel layer; and affixing a cover layer to the gel layer. In a particular embodiment, the mold comprises a vacuum-assist mold. In further embodiments, a method can further comprise the step of placing a release layer in the mold prior to the step of inserting the gel material into the mold.

According to another embodiment, a method of the invention for preparing a support apparatus comprises the following steps: providing a first foam layer comprising a foam piece having a surface with one or more cavities formed therein; inserting a gel material into the one or more cavities in the surface of the foam piece; and at least partially curing the gel material to form one or more gel layers. This method of the invention is particularly characterized in that the foam layer of the support apparatus can function not only as a layer of the apparatus but also as the mold for the gel material. Further, the cavities in the foam can be prepared to be of a size, shape, and distribution such that a wide variety of apparatus gel/foam combinations can be prepared according to desired specifications and uses.

According to yet another aspect, a method for preparing a mattress comprising a gel layer, said method comprising the steps of providing a mold; optionally placing a release layer in the mold; providing a gel material that is a polyurethane gel; inserting the gel material into the mold, thereby forming a gel layer; wherein the gel layer faces a user; optionally, at least partially curing the gel layer; and affixing a cover layer to the gel layer, wherein the gel material has a hardness in the range of 4.5 kPa±1.5 kPa when measured according to a method of ISO 3386-1, and wherein the gel material exhibits a hysteresis of 40%±10%.

According to yet another aspect, a method for preparing a mattress comprising a gel layer and a foam layer, said method comprising the steps of providing a gel material that is a polyurethane gel; preparing a gel layer comprising said gel material and having a top surface and a bottom surface and having a release layer affixed to at least one of said top surface and said bottom surface, wherein the gel layer faces a user; preparing a foam layer having a surface adapted for receiving at least a portion of said gel layer; and affixing said gel layer to said foam layer by a method selected from the group consisting to gluing, stitching, welding, and combinations thereof, wherein the gel material has a hardness in the range of 4.5 kPa±1.5 kPa when measured according to the method of ISO 3386-1, and wherein the gel material exhibits a hysteresis of 40%±10%.

According to one embodiment, an exemplary method of the present invention for preparing a support apparatus does not comprise the co-molding of the gel layer and the foam layer, in order to avoid any kind of problems during the process itself. Moreover, in this way, there are more possibilities to vary the final shape and features of the mattress.

In still another embodiment, the invention provides another method for preparing a support apparatus comprising a foam layer and a gel layer. According to this embodiment, a method comprises the following steps: providing a first foam layer comprising a foam piece with a surface that is at least partially convoluted; and applying a gel material to the convoluted surface of the foam layer to form a gel layer attached to the foam layer. In further embodiments, a method can comprise the step of affixing a cover layer to the apparatus. In a specific embodiment, the cover layer can comprise a second foam layer.

According to one embodiment, the gel material used in the gel layer, in a cured form, is non-toxic to a potential user and provides beneficial and comfortable physical properties. In particular, the gel material comprises a gel having specific physical properties identified as providing increased support pressure and relief to a user, and also providing a user with an increased perception of comfort (i.e., a good “feel”). Further, in the support apparatuses prepared according to the inventive method, the gel layer can be the outermost layer of the apparatus, i.e. it faces the user, therefore being in direct contact with the user. According to further embodiments, the apparatus can also comprise a covering overlying the gel layer. Preferably, the covering layer is not of structure or thickness to substantially reduce or mask the comfort and support provided by the gel layer. Non-limiting examples of coverings encompassed by the invention include a textile layer, a film layer, a coating layer, and a foam layer.

Gels by themselves pose problems for forming mattresses. In fact, they are heavy in bulk and need a base support in order for the beneficial properties of the gels to become evident. Known types of supports (e.g., foam mattresses, cotton batting, or box springs) by themselves do not provide therapeutic support. Rather, known types of supports emphasize pressure points.

In the present invention, it has been discovered that the process for preparing an apparatus by the combination of a gel layer with a traditional support layer combined the advantages of the known supports (e.g., ease of manufacture, light weight) with the advantages of the gel layer (e.g., good comfort and therapeutic benefit).

Through much testing, however, it has been discovered that the concept of “comfort” was not a simple matter and that it indeed included two components: 1) subjective comfort; and 2) objective comfort. Subjective comfort can be described as a “good feel” and can change from person to person. For example, while some individuals prefer a soft bed, others prefer a firm bed. Moreover, even the terms “soft” and “firm” can take on multiple definitions. Accordingly, one goal of the invention was to provide a process for preparing a support apparatus, such as a mattress, that would provide a good feel to a wide range of users. With the combination of the present invention, this result has been achieved, as further explained below. Objective comfort differs from subjective comfort. Objective comfort can be described as therapeutic comfort. This is the type of comfort that is not necessarily sensed by the body but is reflected in the overall effect on the body, such as improved sleep, improved relief of pressure points, and the like. Unfortunately, apparatuses that provide this type of therapeutic benefit do not also provide the good feel a user wants. Accordingly, another goal of the invention is to provide a process for preparing a support apparatus, such as a mattress, that would provide therapeutic benefit (or objective comfort) in addition to subjective comfort.

In addition to the gel and foam layers described in the illustrative embodiments noted above, various aspects of the invention further encompass preparation of support apparatuses comprising one or more additional support layers. These additional support layers can include any type of support material generally known in the art of bodily support apparatuses, particularly in the art of mattresses and seating apparatuses. For example, the one or more additional support layers may include one or more of the following: a foam layer; a spring layer; a textile layer; a gas layer, a wood layer, a metal layer, and a plastic layer. In one particular embodiment, a method of the invention is used in the preparation of a mattress.

According to another embodiment, the gel layer comprises a gel of a specific composition, as better explained below. Such specific composition is particularly useful in modifying the objective and subjective comfort properties of the gel used in the gel layer.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a vacuum-assist mold illustrating a mattress formed therein having a gel layer and a foam layer, said layers being partially cut away to reveal the underlying detail;

FIG. 2 is perspective view of a support apparatus prepared according to one embodiment of the invention comprising a cavity foam layer, wherein the cavities are filled with a gel layer;

FIG. 3 is a perspective of another support apparatus prepared according to one embodiment of the invention comprising a cavity foam layer, wherein the cavities are filled with a gel layer; and

FIG. 4 is a cross-sectional view of a support apparatus prepared according to one embodiment of the invention comprising a foam layer having a convoluted surface covered with a gel layer.

### DETAILED DESCRIPTION OF PREFERRED EMBODIMENTS

The present invention will be described more fully hereinafter in connection with preferred embodiments of the invention which are given so that the present disclosure will be thorough and complete and will fully convey the scope of the invention to those skilled in the art. However, it is to be understood that this invention may be embodied in many different forms and should not be construed as being limited to the specific embodiments described herein. Although specific terms are used in the following description, these terms are merely for purposes of illustration and are not intended to define or limit the scope of the invention. Like numbers refer to like elements throughout. As used in this specification and the claims, the singular forms “a,” “an,” and “the” include plural referents unless the context clearly dictates otherwise.

The present invention provides methods for preparing an apparatus useful for bodily support, particularly support that, in addition to being functional, also provides increased comfort and pressure point relief for a user. A method of the invention generally comprises providing a mold having one or more portions adapted for receiving a gel material, inserting a gel material into the mold, and curing the gel material to form a gel layer. Furthermore, a foam layer may be added to the gel layer. In certain embodiments, the mold comprises a foam layer having a surface with one or more cavities adapted for receiving the gel material.

The gel material used in a method of the invention is stable, non-toxic, and generally known to provide a cushioning effect while maintaining a degree of structural stability and support. In particular, the gel material has a hardness and elasticity that are within a preferred range, as more fully described herein.

In particular, the gel material of the present invention is a polyurethane gel. This gel is resistant to hardening over time, has limited expandability, and is resistant to substance degradation (e.g., from migration of volatile agents, such as plasticizers). Preferably, the gel used according to the invention is also shock absorbent and resistant to vibration.

Polyurethanes are generally understood to be the product of the chemical reaction between a polyisocyanate compound and a polyfunctional alcohol (i.e., a polyol). One example of a general reaction scheme for preparing a polyurethane compound is shown below:

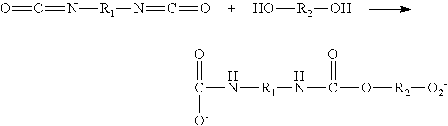

wherein R₁ and R₂ can be various organic groups including, but not limited to, straight or branched chain or cyclic alkyl, alkenyl, or alkynyl groups, as well as various aryl groups.

The gel of the present invention comprises a specific composition of (a) 15 to 62 weight %, preferably 20 to 57 weight %, most preferably 25 to 47 weight % (relative to the sum of components (a) and (b)) of a high molecular weight covalently cross-linked polyurethane matrix; and (b) 85 to 38 weight %, preferably 80 to 43 weight %, most preferably 75 to 53 weight % (relative to the sum of components (a) and (b)) of a liquid dispersing agent which is firmly bonded in the matrix by secondary valence forces; and (c) 0 to 100 weight % (relative to the sum of components (a) and (b)) of one or more additives.

The liquid dispersing agent of component (b) is one or more polyhydroxy compound having an average molecular weight between 1,000 and 12,000, preferably between 1,700 and 6,000 and an OH number between 20 and 112, preferably between 28 and 84, most preferably between 30 and 56. The dispersing agent should contain essentially no hydroxy compounds with a molecular weight below 800, preferably below 1,000.

Elastic gels which can be used in the present invention which are composed of a covalently crosslinked polyurethane matrix and a polyol which is firmly bonded therein (that is to say, without the danger of a troublesome exudation) may only be formed when the isocyanate or polyol components which react with one another have a certain minimum functionality, and when the polyol is essentially free of constituents with an OH number greater than 112 or a molecular weight below 1,000.

Surprisingly, such gels can be prepared by the direct reaction of a polyisocyanate with a higher molecular weight polyhydroxy compound of the type described above if the characteristic isocyanate number is in the range of from approximately 15 to 60, preferably from 20 to 55, most preferably from 25 to 45, and the polyurethane-forming components (isocyanate and hydroxyl compound) are both poly-functional. Otherwise, liquid OH-prepolymers of the type known to those skilled in polyurethane chemistry are formed instead of gels. In the following text, “reaction index” is to be understood as meaning the equivalence ratio (NCO/OH)×100. (e.g. Index=100 means a stechiometric reaction).

In the preparation of the polyurethane matrix, the product of the isocyanate functionality and the polyol functionality should be at least 5.2, preferably at least 6.2, more preferably at least 8, and most preferably at least 10, and more preferably 12. The stated minimum value of 5.2 may be attained when the characteristic isocyanate number is at the upper end of the acceptable range of the present invention (approximately 60) if a mixture composed of about equivalent quantities of a primary and a secondary hydroxy compound is employed as the polyol component.

The product of the isocyanate functionality and the polyol functionality determines different properties in the resulting gel, maintain the same conditions of the chain length. Therefore, gels with have this product different can be different as they have different properties.

Where the characteristic isocyanate number is 50 and a purely primary or secondary polyol component is used, the product of the functionalities should be at least 6.2, preferably 8. Where the characteristic isocyanate number is 30 and a purely primary or secondary polyol component is used, the product of the functionalities should be at least 9, preferably at least 10.

A method of the present invention comprises if appropriate, a catalyst for the reaction between isocyanate groups and hydroxyl groups.

Besides their function as synthesizing components for the polyurethane matrix, the polyol or polyols also act as a dispersing agent. The higher-molecular weight polyols used in the present invention are preferably the polyhydroxy polyesters, polyhydroxy polyethers. Polyhydroxy polythioethers, polyhydroxy polyacetals, polyhydroxy polycarbonates or polyhydroxy polyesteramides of the molecular weight range given above, which compounds are liquid at room temperature. Such compounds are known to those in the art of polyurethane chemistry.

The process for the preparation of polyurethane gels of the present invention is preferably carried out at room temperature. However, increasing the temperature up to 100° C. increases the reaction rate.

The step of forming a gel layer is obtained by allowing the mixture of components (a), (b), and (c) to gel.

Gels, such as polyurethane gels, are generally recognized as imparting a balanced pressure distribution. Unlike standard padding materials, which react to an applied pressure, such as a user sitting or lying of the padding, by deforming along only the axis of the applied pressure (i.e., the axis perpendicular to the plane of the padding), gels tend to exhibit tri-dimensional deformation properties. In other words, the gel reacts to the applied pressure by deforming along three axes: the X and Y axes in the plane of the gel surface, as well as the Z axis that lies perpendicular to the plane of the gel surface. This leads to an even distribution of the exerted pressure, which lessens the pressure felt by the user at the pressure points. Accordingly, in addition to providing added comfort, the gel provides health advantages, such as increased blood circulation, encouragement of correct posture, and alleviation of pressure concentration, which can lead to serious conditions, such as bed sores, or other types of ulcerations.

However, through a high number of tests, it has been found that a simple combination of a gel layer with a traditional support apparatus, such as a foam mattress, does not result in the desired effect. In fact, gel formulations are highly varied and provide a great number of different properties. Through testing, it has been determined that two properties, hardness and elasticity (or hysteresis) were crucial to providing a final combination product (i.e., the combination of the gel layer and the underlying support layer) that exhibited the correct ranges of hardness and hysteresis to provide both subjective comfort and objective comfort. Prior to the present invention, any work was known where the subjective and objective comfort provided by a combined gel layer and underlying support layer (e.g., foam layer) was evaluated by testing the hardness and hysteresis of the gel. Likewise, prior to the present invention, any work was known that indicated these two physical properties could be related to a gel structure to evaluate the support benefits of the gel. Accordingly, a method of the present invention is the first method and realization that a gel of a specific composition having a hardness within a specific range and a hysteresis within a specific range could provide this combined subjective and objective support effect, particularly in consideration of the presence of the underlying support layer as well.

The gel materials used in various aspects of the invention are characterized by the specific physical properties they exhibit, in particular by, as indicated above, hardness and elasticity. Optimization of these two properties exhibited by the gel allows for preparation of a gel layer (and ultimately an overall apparatus) providing both objective and subjective comfort and support.

In other words, gels according to the invention having a certain degree of hardness and a certain degree of elasticity provide therapeutic benefits (i.e., objective comfort), as previously described, but also provide a user with a good “feel” (i.e., subjective comfort). The ability to provide both objective and subjective comfort is particularly useful because a support apparatus designed to provide therapeutic benefit to a user may not always feel good to the user. Conversely, what feels good to a user may not always provide therapeutic benefit to the user. However, gel materials used in various aspects of the present invention having a hardness and elasticity within the presently specified ranges provide both objective and subjective comfort.

A person skilled in the relevant arts would be expected to seek out material having a good perceived comfort for use in preparing a support apparatus. For example, such a skilled person would be expected to choose a material having a hardness providing subjective comfort to the user. However, only according to the present invention has it been found that merely optimizing a single material property, such as hardness, to provide a good feel to a user is insufficient to provide a support apparatus that provides both subjective and objective comfort for a user.

Based upon known technology, a skilled person may prepare an apparatus to have a physical property within a certain range of values. The present invention reveals, however, that such range can change when the underlying material is further optimized in relation to other values necessary to provide both subjective and objective comfort to a user. Accordingly, the values for the physical properties described herein have been established through testing and evaluation to balance off-setting nature of various gel physical properties and arrive at a desired gel formulation that provides a good feel to the user but also provides therapeutic benefit.

This is a distinct advantage over the art in that changing a single physical property may lead to a support apparatus that is comfortable to one user but uncomfortable to another user and fails to provide therapeutic benefit to either user.

The gel used in the present invention, however, is the culmination of rigorous testing to provide a gel material having hardness and hysteresis values that give the gel a good feel to a variety of users while also providing therapeutic benefit. As such, the range of values provided herein provide for a gel material having properties and effects that are unexpected in light of the know art and that provide distinct benefits not provided by gel materials having hardness and hysteresis values outside of the disclosed ranges.

Above-mentioned rigorous tests to determine the correct value ranges for hardness and hysteresis have been carried out. Moreover, a specific test has been conceived directly from the Applicant, in order to evaluate obtained resulted ranges with the subjective and objective comfort that has to be provided by the support apparatus of the invention. The test was a comparison of pressure distribution of a gel sheet used as a topper in a mattress construction.

The pressure distribution test has been carried out in order to understand the effect of different hardness and hysteresis in final property of gel sheet used as topper in mattress construction and to choose the right range of hardness and hysteresis.

Gel, as every other material, has a range of hardness; in this range it is possible to choose different hardness for the specific purpose. For a mattress the identified range is 0.5-50 KPa. As far as the property of hysteresis, in order to have a not very elastic and a not complete viscoelastic material, the identified range is of 15-85% of hysteresis.

In this test, six different mattress combinations were tested. In each case, a gel sheet 79 cm×77 cm×1.5 cm was laminated over a foam layer having a density of 30 Kg/m³ and hardness of 2 KPa and dimensions of 83 cm×104 cm×1.5 cm. The combination was positioned over a block foam having the same density and hardness but having dimensions of 200 cm×80 cm×10 cm. The properties of the test gels are provided in the Table 1.

The first four materials are inside the range of 15-85% of hysteresis, while two materials are out of this range (but one inside the range of hardness and the other outside the range of the hardness) to make the comparison.

TABLE 1

| ID | Hardness | Hysteresis |
|---|---|---|
| TGI0525 | 3.1 KPa | 45.7% |
| RE30 | 11 KPa | 63% |
| RE40 | 41 KPa | 68% |
| BTG | 91 KPa | 63% |
| TGI0710 | 98 KPa | 1% |
| TGI0711 | 43.9 KPa | 2.4% |

The specific gel composition of said materials is as follows:

TABLE 2

| | | | Product | |
|---|---|---|---|---|
| | | | isocyanate | |
| | | | functionality | |
| | | | and polyol | |
| ID | Polyols | OH number | functionality | Index |
| TGI0525 | long chain | between 20-112 | 12 | 30% |
| | polyols | | | |
| RE30 | mix long | a part | 8 | 33% |
| | and short | between 20-112 | | |
| | chain | and a | | |
| | polyols | second part | | |
| | | >112 | | |
| RE40 | short chain | >112 | 12 | 25% |
| | polyols | | | |
| BTG | long chain | between 20-112 | 6 | 60% |
| | polyols | | | |
| TGI0710 | long chain | between 20-112 | 9 | 35% |
| | polyols + | | | |
| | plasticizer | | | |
| TGI0711 | long chain | between 20-112 | 12 | 30% |
| | polyols + | | | |
| | plasticizer | | | |

Polyols are used both in the polyurethane matrix (a) formation and as the liquid dispersing agent (b). In fact, both the polyurethane matrix (a) and the liquid dispersing agent (b) comprise polyols. The distribution among (a) and (b) is regulated and determined by the index.

The test method had five people of different height, weight, and gender, without any orthopedic pathologies to lie back on the mattress for five minutes. During this time, pressure distribution was tested using an Xsensor X5 sensor map apparatus from X-Sensor Technology Corporation (Calgary Alberta Canada). This particular instrument uses software that separates the total sensor input into a number of individual sensor readings depending upon the pressure distribution. Moreover the pressure map gives a visual indication of which material is the best pressure distributor. In other words, when the body pressure is widely distributed across the gel, a higher number of individual sensor readings are provided. In comparison, when the body pressure is less widely distributed across the gel, a lesser number of individual sensor readings are provided.

To understand materials' behavior, the analysis is going to focus difference between the six used materials. The tables below present mean values for all five people tested.

For testing purposes, the pressure of 36 mmHg was set as the benchmark for pressure discomfort. This value is reported by Landis, E M, (1930) “Micro-injection studies of capillary blood pressure in human skin,” Heart, 15:209-228. Capillaries are closed above this pressure threshold, and blood thus does not reach the external skin layers, resulting is discomfort. Evaluation was thus a count of the total number of sensors that registered a pressure above this limit.

For each test subject, the raw data has been verified to establish multiple evaluations of the test materials.

The total percentage of sensors registering a pressure above the 36 mmHg threshold has been evaluated. As noted previously, blood capillaries are closed above this value resulting in reduced blood flow (or no blood flow) to the skin. A high percentage of sensor readings above this threshold indicate a high level of objective discomfort, and a person would automatically be induced to change position to open capillary flow. This is the type of mechanism underlying multiple position changes during sleeping, which correlates to sleep that is not restful. Results are shown in the Table 3 of comparison below.

All the results coming through the test are plotted in a table of comparison where, after the first column indicating samples, there are: a column with the number of sensors that gauge a pressure, a column with the number of sensors over 36 mmHg, another column with the percentage of the sensors over 36 mmHg and in the last one the percentage of sensors compared to TGI0525.

Data of the last column are normalized to the total sensor of TGI0525, in order to reach the possibility to compare the values (i.e. For RE30: 126-58=68, this is the number of sensors more than TGI0525, that is then divide for 58 to have the estimation of percentage of sensors over the 36 mmHg more than TGI0525, 68/58=1.17 that means 117% more).

### Table 3 of Comparison

| | | | | Percentage |
|---|---|---|---|---|
| | Total | Sensors | | compared to |
| ID | sensors | ≧36 mmHg | Percentage | TGI0525 |
| TGI0525 | 1610 | 20 | 1.1 | 0% |
| RE30 | 1395 | 72 | 4.9 | 491% |
| RE40 | 1301 | 110 | 8.3 | 742% |
| BTG | 1201 | 194 | 15.5 | 1432% |
| TGI0710 | 1269 | 148 | 11.4 | 1028% |
| TGI0711 | 1065 | 160 | 14.5 | 1303% |

The percentage of sensors over 36 mmHg pressure is very low for TGI0525 (3.2%) and increase to 26% for TGI0710 and 28% for BTG. This means that one third of the body has the capillaries close. For TGI0525 only a small amount of capillaries are closed, that reveal a higher comfort and a less probability that the body feel discomfort, allow a rest position through the sleep.

After that, considering the total number of sensors used, the total area of contact (of the same person) across the gel layer of each test material has been compared. The greater the total area of contact, the better the weight distribution of the person across the gel. Better weight distribution is a good indicator of better comfort and is therapeutic since it leads to less pressure at any one given point.

TABLE 4

| ID | Total sensors | Area (cm²) | Percentage |
|---|---|---|---|
| TGI0525 | 1610 | 4088 | 0% |
| RE30 | 1395 | 3540 | −13.5% |
| RE40 | 1301 | 3306 | −19.1 |
| BTG | 1201 | 3050 | −26 |
| TGI0710 | 1269 | 3224 | −21.3 |
| TGI0711 | 1065 | 2704 | −33.9 |

This indicates that the pressure of the body is well distributed on TGI0525 and poorly distributed on other samples.

Moreover, the maximum peak pressure value at any point across the gel layer has been evaluated. This closely follows the hardness values of the gel.

TABLE 5

| ID | Peak pressure (in mmHg) |
|---|---|
| TGI0525 | 40.8 |
| RE30 | 54.1 |
| RE40 | 74 |
| BTG | 99.9 |
| TGI0710 | 84.7 |
| TGI0711 | 87.8 |

Also for this parameter the best value is given from TGI0525. Moreover the value follows the change in hardness and hysteresis, as a gel out of the hysteresis range doesn't fulfill the parameter of peak pressure.

Furthermore, the average pressure on the body for each gel layer has been evaluated. Less overall pressure correlates to a better subjective comfort. Accordingly, with the above testing procedure, a real-life evaluation of the subjective and objective comfort provided by the present inventive combination has been established.

TABLE 6

| ID | Average pressure (in mmHg) |
|---|---|
| TGI0525 | 18.4 |
| RE30 | 20.5 |
| RE40 | 22.1 |
| BTG | 25.3 |
| TGI0710 | 24.2 |
| TGI0711 | 24.2 |

The table shows how, still for this parameter, the values change with hardness, reaching a higher value; so this means a higher level of discomfort, for higher hardness and hysteresis out of range.

For each of the five test subjects, sample TGI0525 consistently provided the benchmark for subjective and objective comfort with sample RE30 following closely behind. Sample TGI0525 features a hysteresis of 45.7% and a hardness of 3.1 KPa, as shown in the table 1 above. Samples BTG, TGI0710, and TGI0711 provided the worst results, these samples having hardness and/or hysteresis values outside of the identified ranges needed to provide the necessary subjective and objective comfort. It was surprising to find that simple variations in hardness and hysteresis could result in changes to one or both of subjective or objective comfort, sometimes depending upon the specific subject being tested.

Arriving at the specifically claimed ranges of hardness and hysteresis is not simply a matter of routine optimization. As pointed out earlier, anyone in the art has previously recognized that these two properties were crucial to providing both subjective and objective comfort to a user. Moreover, it is not the matter to simply provide a gel layer alone. Rather, it is provided as overlying another support layer. The specified ranges of hardness and hysteresis are the ranges in which optimization could now occur depending upon the underlying support layer. In other words, in light of this, one of skill in the art could now use this invention as the starting point to find the best hardness and hysteresis values (within our claimed ranges) to match a gel with a specific type of underlying support layer (e.g., foam, wood, cotton, etc.).

Methods of the present invention demonstrate surprisingly that the identified and presently claimed ranges of hardness and hysteresis are crucial to providing a superior combination of both subjective and objective comfort, as compared with the characteristics of known supports. These properties are also linked to the specific combination of the gel.

In other words, these ranges are surprisingly crucial to provide a combination apparatus that a wide variety of users with subjectively rate as comfortable but will simultaneously provide objective comfort by properly distributing pressure to avoid capillary closure. It was surprising to find that small alterations in these properties can drastically affect the critical capillary closure pressure. Prior art does not disclose or suggest the claimed hardness and hysteresis ranges, nor does it teach or suggest the calibration/optimization of two variables at the same time—hardness and elasticity. The presently claimed invention teaches the adjustment of multiple variables, and here, calibration of the two physical properties of hardness and elasticity was advantageously found to provide both objective (therapeutic) and subjective (good feel) comfort to the user.

Particularly, the gel material is characterized by having a low degree of hardness, such hardness being measurable as the force deflection of the gel at a specific compression. Gel hardness can be measured according to any known method, and a gel useful according to the invention can be identified as having a hardness in a specified range. One method particularly useful according to the invention for measuring gel hardness is the testing method ISO 3386-1 (year 1986 version), as designated by the International Organization for Standardization (ISO).

According to ISO 3386-1, a method is provided for the calculation of the compression stress value of various materials. The compression stress/strain characteristic is a measure of the load-bearing properties of the material, and the testing method provides two formulas for calculating the compression force deflection in kilopascals (kPa), which provides a measured hardness of the material.

Specifically, under the ISO 3386-1 standard, a gel according to the invention can be measured for a hardness determination through a compression load deflection test. In particular, a 5 cm×5 cm×2.5 cm gel sample is subjected to a compressive force, with a 70% maximum compression, and gel hardness is measured as the stress applied to the gel (in kPa) at 40% compression. Such testing would typically be performed after the gel material has been allowed to cure (i.e., formation of a gel layer).

As indicated, the gel material useful in various aspects of the invention has a low measurable hardness. Particularly, the gel has a measurable hardness that is in the range of 4.5 kPa±1.5 kPa.

The gel material used in various aspects of the invention is further characterized by having a measurable elasticity that is within a specified range. In solid mechanics, a material is understood to behave elastically if it changes shape due to an applied load, and when the load is removed, the material recovers its original shape. The elasticity of a material is inversely proportional to its stiffness.

One method for evaluating the elasticity of a gel for use according to the invention is through determination of the hysteresis exhibited by the gel. Hysteresis is a property of systems (usually physical systems) that do not instantly follow the forces applied to them, but react slowly, or do not return completely to their original state. Hysteresis, then, can be evaluated as the ability of a material, such as a gel, to return to its original shape after removal of a force on the gel.

In one method for determining hysteresis, a force is applied to a gel, which leads to compression of the gel. The deflection of the force by the gel at 70% compression is measured, and the external force is removed, allowing the gel to decompress. The deflection of the gel under no compression (i.e., after removal of the force) is then measured. The hysteresis of the gel (evaluated as a percentage) is the difference between the two force values at the defined deflections. Accordingly, a gel exhibiting a low hysteresis percentage would be expected to be highly elastic, in other words, have a rapid and significantly complete return to its original shape. A gel exhibiting a high hysteresis percentage would be expected to be less elastic, in other words have a more delayed and less complete return to its original shape. Again, according to the invention, such testing would typically be performed on a gel layer after the gel material has been allowed a sufficient time to cure or mature.

Preferably, the gel materials used in the inventive method exhibit an elasticity (or percentage hysteresis) that is not temperature dependent. In particular, it is preferable for the gel material to have an elasticity that lacks temperature dependence within a range of temperatures that is well tolerated by potential users (e.g., temperatures in climatic conditions wherein a support apparatus incorporating the gel may be used). Even more particularly, the absence of temperature dependence is within a range of temperatures commonly found in dwellings (such as between about 10° C. (50° F.) and about 45° C. (110° F.)). Particularly, the gel used in the invention has a measurable hysteresis in the range of 40%±10%.

Another additional important feature of the present invention is that a compact not-expanded material, as the gel of the present invention, with the above-indicated softness values was not considered suitable for life span needed for mattresses. However, tests were carried out and the mattress of the present invention had doubled the requested cycles.

Moreover, the gel layer of the present invention, on the surface facing the user can be smooth or comprising a plurality of small towers that arise from the planar surface thereof.

In this way, the small towers can help in the tridimensional deformation of the gel and the support apparatus itself under the weight of the user. Moreover, small towers are separated the one from the other by channels free of material that allow a free circulation of air in order to improve the ventilation of the surface of the support apparatus facing the user.

In addition to the gel layer, a support apparatus prepared according to a method of the invention further comprises one or more foam layers. The gel layer and the foam layer can be integrally attached or can be separate bodies. By integrally attached is intended to mean the layers are attached one to another by means such that the two layers are not separable without at least partially damaging one or multiple layers. For example, the layers may be integrally attached, such as by gluing, stapling, sewing, welding, or the like. Further, the layers may be integrally attached through chemical bonding. For example, when the gel layer comprises a polyurethane gel and the foam layer comprises a polyurethane foam, both layers have free isocyanate groups prior to curing (or maturation) of the gel or foam. Accordingly, when one layer is allowed to cure while adjacent the other layer, chemical bonding between the gel material and the foam material can occur.

Foam support layers are particularly useful in combination with a gel layer, not only because of ease of bonding, as described above, but also because of the various combinations provided. For example, in one embodiment, convoluted foam may be used. In another embodiment, the foam may have one or more cavities for receiving all or part of the gel layer. When such cavities are present, the cavities may be on a “top” surface of the foam, a “bottom” surface of the foam, or on both a top and bottom surface of the foam. As such, the top surface or the bottom surface may be particularly defined as the surface intended for contact with the body of a user.

A support apparatus prepared according to various aspects of the invention can comprise apparatuses such as mattresses. Moreover, a method of the invention can be used in the preparation of an apparatus in a substantially complete form (i.e., requiring no further essential components to perform its support function) or can be used in the preparation of a component part of an apparatus (i.e., a component that can be combined with one or more further components to form a substantially complete support apparatus). For example, a mattress component could be a mattress topper that could be combined with an existing mattress.

In one embodiment of the invention, a method for preparing a support apparatus comprising a gel layer and a second layer is provided. In specific embodiments, the second layer comprises a foam layer. A method generally comprises providing a gel layer, providing a second layer, and affixing the gel layer to the second layer. A method can further comprise one or more steps related to preparing the gel layer, preparing the second layer, or preparing both the gel layer and the second layer. A method can still further comprise applying one or more further layers to the support apparatus, particularly in embodiments wherein the second layer is a foam layer.

A method according to the present invention comprises the following steps: providing a polyurethane gel that is obtained by providing a gel material of the following composition:

(a) a high molecular weight covalently cross-linked polyurethane matrix at 15 to 62 weight % or 20 to 57 weight % or 25 to 47 weight %, relative to the sum of components (a) and (b);

(b) a liquid dispersing agent which is firmly bonded in the matrix by secondary valence forces at 85 to 38 weight % or 80 to 43 weight % or 75 to 53 weight %, relative to the sum of components (a) and (b); and

(c) one or more other additives at 0 to 100 weight %, relative to the sum of components (a) and (b);

wherein the gel material has an isocyanate number in the range of 15 to 60 or 20 to 55 or 25 to 45, and the isocyanate and hydroxyl compounds forming the polyurethane are both poly-functional;

mixing the components (a), (b) and (c);

reacting the components (a), (b) and (c).

Moreover, it comprises the step of providing the liquid dispersing agent of component (b) that is one or more polyhydroxy compound having an average molecular weight between 1,000 and 12,000 or between 1,700 and 6,000 and an OH number between 20 and 112 or between 28 and 84 or between 30 and 56, wherein the dispersing agent does not contain hydroxy compounds with a molecular weight below 1,000 or below 800.

A method according to the invention comprises a step of preparing the polyurethane matrix by reacting isocyanate and polyol compounds and, in the preparation of the polyurethane matrix, the product of the isocyanate functionality and the polyol functionality is at least 5.2 or at least 6.2 or at least 8 or at least 10 or 12.

A method according to the present invention comprises an optional step of providing a catalyst for the reaction between isocyanate groups and hydroxyl groups.

The invention is particularly characterized in that the various aspects provided herein is fully adaptable to a number of different processing modes. For example, various aspects of the invention can be used in continuous processing methods or can be used in discrete methods where individual articles are prepared. Such advantages are more fully described below in relation to particular embodiments of the invention; however, the invention is not limited to steps described only in relation to a particular embodiment. Rather, various aspects of the invention may be adapted to particular manufacturing strategies and plans as would be envisioned by the skilled artisan.

The invention may incorporate the use of one or more molds. For example, in one particular embodiment, a method comprises providing a mold, inserting a gel material into the mold to form a gel layer, and affixing a cover layer to the gel layer. Optionally, the gel material may be at least partially cured (or matured) to form the gel layer prior to affixing the cover layer. In one particular embodiment, the cover layer is a foam layer. In another particular embodiment, the cover layer is a textile layer.

A mold used according to the invention can be any type of conventional mold that would be recognized as useful in forming one or both of a gel layer and a foam layer. The size of the mold can vary depending upon the support apparatus being prepared. Further, the size of the mold can vary depending solely upon the dimensions of the gel layer being prepared in the method. In one particular embodiment, wherein the apparatus being prepared is a mattress, the dimensions of the mold used are substantially similar to the dimension of the mattress being prepared. For example, a double (or full) size mattress generally has a width and length of about 135 cm (about 54 inches) by 190 cm (about 75 inches). Accordingly, when preparing a mattress for a double bed, a mold used according to the invention would have similar dimensions. Thus, a support apparatus prepared according to the present invention to be a mattress can be prepared such that the apparatus is dimensioned to be a mattress (i.e., have the length, width, and thickness of a standard mattress). In further embodiments, the support apparatus can be sized to have at least one dimension of a standard mattress size. For example, the support apparatus could be sized to the width of a mattress, the length of a mattress, or both the length and width of a mattress.

In further embodiments, the support apparatus can be specifically dimensioned for a specific application. For example, in one embodiment, the support apparatus can be prepared such that it is dimensioned to be a mattress topper. Accordingly, one of skill in the art would recognize such dimensions would be significantly equivalent to the length and width of a standard mattress (e.g., twin, double, queen, or king) but have a thickness in the range of about 0.1 cm to about 10 cm. In specific embodiments, the mattress topper can have a thickness in the range of about 0.2 cm to about 9 cm, about 0.3 cm to about 8 cm, about 0.4 cm to about 7 cm, about 0.5 cm to about 6 cm, about 0.1 cm to about 5 cm, about 0.25 cm to about 5 cm, or about 0.5 cm to about 5 cm.

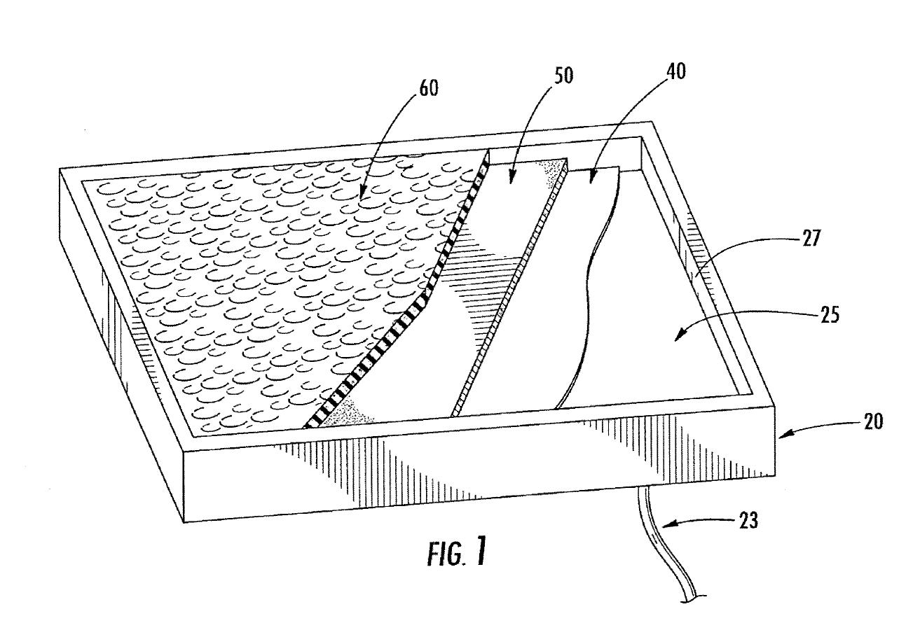

An example of such a mold is provided in FIG. 1, which shows a mold with a mattress thereon prepared according to the method described above. The individual components of the mattress are cut away to reveal detail of the underlying elements. In FIG. 1, the mold 20 is a vacuum-assist mold and includes a vacuum tube 23 attached to the mold 20 and exiting therefrom to suitable vacuum means (not shown). The mold 20 has an interior surface 25 formed by sidewalls 27 and is adapted for receiving the materials used in preparing the mattress, said sidewalls 27 having a height useful to define a cavity for containing at least the desired thickness of the gel layer of the mattress. In the case of a vacuum-assist mold, the mold 20 comprises further components necessary for providing vacuum suction to the interior surface of 25 of the mold 20. Of course, this method of the invention is not limited to the use of a vacuum-assist mold, and the mold apparatus illustrated in FIG. 1 is provided only as one embodiment of the invention and should not be construed as limiting thereof.

Optionally, the method described above can further comprise providing a release layer prior to inserting the gel material. As illustrated in FIG. 1, the release layer 40 lines the interior surface 25 of the mold 20. The release layer, according to the invention, can comprise any material useful for facilitating removal of the gel layer from the mold. In certain embodiments, the release layer can further function as a covering for the gel layer to avoid direct contact of the gel layer with an individual or another component of a support apparatus, particularly to avoid the “tacky” feel often characteristic of a gel, even subsequent to complete curing or maturation of the gel material. In certain embodiments, a release layer is not required. For example, the mold could comprise a finish that substantially functions as an inherent release layer, such as in the case of a mold having at least a portion of the interior surface coated with a TEFLON® layer.

In one particular embodiment, the release layer comprises a polymer film, such as a polyurethane film. The polymer film can be of varying thickness, for example in the range of about 0.01 mm to about 2 mm. In one embodiment, the polymer film has a thickness of about 0.025 mm to about 1 mm. Preferably, the polymer film is of a minimum thickness to provide effective release of the gel layer from the mold and also to avoid tearing over long-term use as a covering for the gel layer. In one embodiment, the polymer film is a polyurethane film.

According to another embodiment, the release layer can comprise a liquid coating layer. The material used in the liquid coating can be any liquid material generally recognized as being useful for disallowing attachment of a gel material, such as polyurethane gel, to a surface, such as wood, metal, plastic, or ceramic, that may be used in a mold. Non-limiting examples of materials useful in a liquid coating according to the invention include silicones and fluorocarbons. The liquid coating can be applied to the mold by any means generally recognized as useful in the art including, but not limited to, spraying, brushing, rolling, dipping, and the like.

In another embodiment, the release layer can comprise a waxy layer. Generally, a waxy layer according to the invention can comprise any material recognized as being a wax (e.g., a low-melting organic mixture or compound of high molecular weight that is solid at room temperature and generally similar in composition to fats and oils except that it contains no glycerides). Non-limiting examples of waxes useful according to the invention include animal waxes (e.g., beeswax), vegetable waxes (e.g., carnauba), mineral waxes (e.g., fossil or earth waxes, such as silicon based waxes, or petroleum waxes, such as paraffin), ethylenic polymers and polyol ether-esters (e.g., CARBOWAX®), chlorinated naphthalenes (e.g., halowax), and hydrocarbon-type waxes.

According to yet another embodiment, the release layer can comprise a powder. For example, in one embodiment, the release layer can comprise a non-reactive powder, such as magnesium silicate hydroxide (i.e., talc), or a similar powder.

When a liquid coating or powder is used as the release layer, the coverage of the release layer is generally limited by the dimensions of the mold. When a polymer film is used, however, it may be useful to use a film having dimensions greater than the dimensions of the mold, thereby allowing the release layer to have free edges extending outside the edges of the gel layer. The free edges of the release layer can be later trimmed or used in further, optional process steps as more fully described below.

Returning to FIG. 1, in reference to the method described above, once the optional release layer 40 is placed in the mold 20, the gel material is inserted into the mold 20, over the release layer 40. The gel material can be any gel material, as described herein. In a particular embodiment, the gel material is a polyurethane gel. The gel material can be inserted into the mold by any means recognized as useful in the art and can vary according to the manufacturing environment. For example, in a continuous, automated process, the gel can be inserted by a flow-regulated nozzle under computer control, wherein a defined volume of gel is flowed or sprayed into the mold, thereby filling the mold with gel to a defined thickness. In a discrete manufacturing process, the gel could be poured into the mold under human control.

Once the mold is filled with the gel material to the desired thickness, the gel can be referred to as the gel layer 50. While not necessarily required, in certain embodiments, the gel layer 50 is allowed to at least partially cure prior to proceeding with the remaining process steps. By curing, it is intended to mean that the gel is allowed to undergo chemical reactions that may be taking place in the transformation of the gel material from a raw material to its finished, gelled state. For example, in the case of a polyurethane gel, such chemical reactions can include reaction of isocyanate moieties and alcohol moieties to form polyurethane, as fully described above. Curing, which can also be referred to as maturation, may also encompass a physical component wherein the gel material transforms from a liquid to a gelled state. In certain embodiments, it is preferable to allow at least partial curing or maturation to occur such that the gel material begins to take on a certain degree of internal structuring to allow for continuing with the remaining process steps without significantly deforming the gel layer (i.e., interfering with the formation of a gel layer having a substantially smooth or level surface rather than having ridges or valleys).

As previously noted, curing is an optional step that is actually preferably omitted in certain embodiments, such as where chemical bonding between the gel layer and another layer is desired.

After formation of the gel layer, the present method further comprises affixing a cover layer to the gel layer. The cover layer can comprise any material useful for providing additional structure or support to the gel layer or any material useful for simply acting as a barrier layer between the gel layer and another layer or a user. For example, the cover could comprise a textile layer, a foam layer, a natural material, such as leather, a synthetic material, or the like. In further embodiments, the cover layer can also be a material otherwise useful as a release layer, such as polymer film, a textile layer, a liquid coating layer, a waxy layer, or a powder layer.

As illustrated in FIG. 1, the cover layer comprises a foam layer 60, which has a length and width substantially corresponding to the length and width of the gel layer 50; however, the foam layer 60 can have a variable thickness. For example, in certain embodiments, such as preparation of a mattress topper, is may be desirable for the foam layer to be of minimal thickness (e.g., less than or equal to the thickness of the gel layer) to emphasize the benefits of the gel layer without imparting unnecessary bulk to the mattress topper. In other embodiments, such as preparation of a mattress, it may be desirable for the foam layer to be of a greater thickness to impart an overall thickness approaching the thickness of a conventional mattress.

As used herein, affixing is intended to refer to any method of fastening, joining, or attaching the gel layer to the foam layer that may be recognized as useful. Affixing the layers can comprise a physical bonding of the layers as well as a chemical bonding of the layers. Non-limiting examples of physical bonding whereby the layers are affixed include gluing, stitching, and welding. Furthermore, the affixation of the layers can be facilitated solely by the inherent “tackiness” of the gel layer. Chemical bonding of the layers can occur in any process wherein the gel layer and the foam layer comprise free reactive groups capable of reacting with one another. For example, the gel layer may comprise a polyurethane gel material, and the foam layer may comprise a polyurethane foam material. The reaction of isocyanate groups in one layer with alcohol groups in the other layer would be expected to lead to chemical bonding between the layers. Such chemical bonding is further described in Published U.S. Patent Application No. 2001/0018466, the contents of which are incorporated herein by reference in their entirety.

In addition to the above steps, according to one embodiment, a method may further comprise affixing the free edges of the release layer, when applicable, to the gel layer and/or the cover layer. Such affixing can be accomplished by any means recognizable as useful including, but not limited to gluing, stitching, and welding.

According to another embodiment of the invention, the method further comprises combining the cover layer and the gel layer with one or more additional layers. The additional support layer can include any type of material generally recognized in the art as being useful for providing support to at least a portion of the body of a user. For example, the additional support layer can comprise a layer of foam, which can take on any of the various embodiments generally useful for providing a cushioning effect or a supportive effect. The additional support layer can also comprise springs, which are recognized as being useful for providing support to the body. The layer of springs can take on any embodiment known in the art for providing effective support, while also providing comfort for the user. For example, the spring layer can comprise a series of springs that are at least partially interconnected. Furthermore, the spring layer can comprise a series of springs that are present as separate coils. Further additional embodiments of spring layers are also encompassed by the present invention, which is not intended to be limited by the examples provided above. Further, the additional layers can be affixed to one or both of the gel layer and the cover layer. Moreover, affixing the additional layer is not required, but it can rather be merely associated with the gel layer and the cover layer in a readily separable fashion. For example, the additional layer could comprise a cavity foam, and the support apparatus formed of the gel layer and the cover layer could be prepared as an insert for the cavity in the foam. Non-limiting examples of additional layers for combination with the gel layer and the cover layer include a foam layer, a spring layer, a textile layer, a gas layer, a wood layer, a metal layer, a plastic layer, and combinations thereof.

In addition to the use of conventional molds, the “mold” of the present invention can also be described in a broader sense. For example, in one embodiment, the invention is directed to a method of preparing a support apparatus, such as a mattress, wherein the mold comprises a foam piece having a surface with one or more cavities formed therein. Accordingly, a method can comprise inserting a gel material into the cavities of the foam piece, thereby forming a support apparatus comprising a gel layer and a foam layer, wherein the foam layer also serves as the mold for the gel. A method can include further steps depending upon the type of apparatus being prepared. For instance, in one embodiment, a method can further comprise at least partially curing the gel layer. In another embodiment, a method can further comprise affixing a second foam layer to the gel layer. The second foam layer may be of dimensions useful for covering the gel layer, or the second foam layer may be of large dimensions, such as being useful for covering substantially the entire surface of the foam layer, including the gel layers formed therein. The invention can still further comprise applying a covering layer (particularly to the gel layer), such as a polymer film, a textile layer, or a liquid or powder coating layer. Moreover, a method can encompass combination with one or more further support layers, such as previously described herein.

In further embodiments, the mold can comprise still further materials. In a specific embodiment, the mold comprises one or more layers of a support material having one or more cavities formed therein for receiving the gel material. For example, the mold can simply be a foam piece as described above, wherein the foam has a defined average thickness and has a surface with one or more cavities formed therein. In another embodiment, the mold comprises a textile layer having one or more cavities formed therein. In still another embodiment, the mold comprises a sandwich textile comprising a foam layer between a first textile layer and a second textile layer, wherein the foam layer has one or more cavities formed therein.

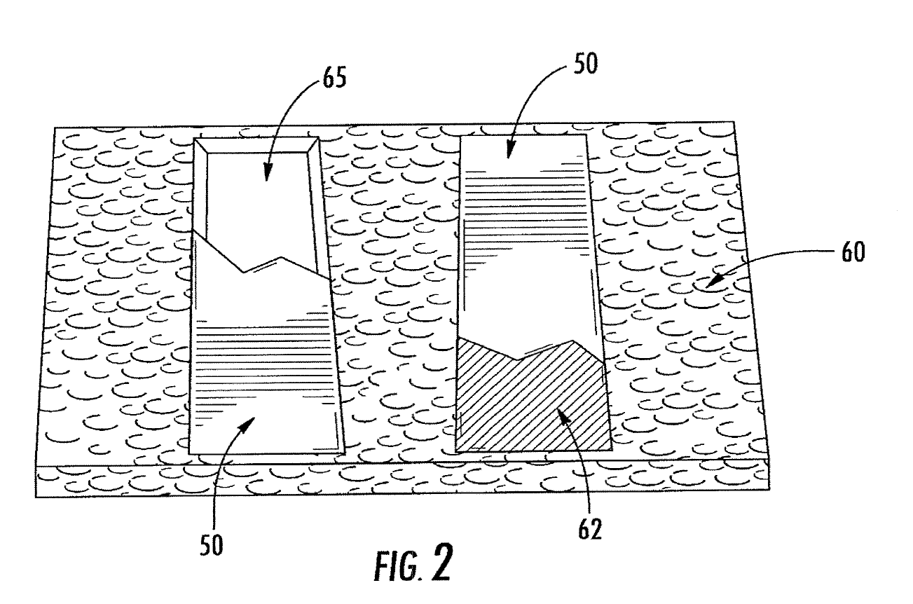

One embodiment of a support apparatus prepared according to this method of the invention is illustrated in FIG. 2. As seen therein, the apparatus prepared according to the invention comprises a foam layer 60 having a surface with two cavities (left and right) formed therein. The left cavity 65 is filled with a gel layer 50 that is partially cut away to reveal the cavity 65. The right cavity is also filled with a gel layer, but the gel layer is covered with a cover layer 62. The cover layer 62 is shown partially cut away to reveal the underlying gel layer 50.

When performing a method according to this embodiment of the invention, it is particularly useful for the foam layer to be of a substantial thickness for imparting structure to the apparatus. For example, in one embodiment, the foam layer has a thickness of at least about 5 cm. In further embodiments, the foam layer has a thickness of at least about 6 cm, at least about 7 cm, at least about 8 cm, at least about 9 cm, and at least about 10 cm.

As in the embodiments described above, the cover layer can comprise a variety of different materials. For example, the cover layer could comprise a textile layer, a film layer, a foam layer, a powder layer, a natural material, such as leather, a synthetic material, or the like. In a particular embodiment, the cover layer comprises a second foam layer.

When a second foam layer is used as the cover layer, it is generally preferable for the second foam layer to be of a thickness such that the beneficial properties of the gel layer are not negated by the foam. For example, in one embodiment, the second foam layer has a thickness of less than about 5 cm. In further embodiments, the second foam layer has a thickness of less than about 4 cm, less than about 3 cm, or less than about 2 cm. In yet further embodiments, the second foam layer has a thickness of about 0.25 cm to about 5 cm, about 0.5 cm to about 4 cm, or about 0.75 cm to about 3 cm.

The foam layer can further be characterized by the shape, positioning, and dimensions of the cavities formed therein. For example, the cavities may substantially cover the top surface of the foam as one continuous cavity or a plurality of cavities. Alternately, the cavities may be formed in strategic positions in the foam layer, such as to substantially correspond to certain body parts of a user or to impart specific beneficial effects. Moreover, the cavities can take on specific shapes, such as to correspond to the shape of a specific body part of a user generally or to again impart beneficial properties.

In one embodiment, the cavities formed in the foam layer have a depth of about 10% to about 90% of the average thickness of the foam layer. More particularly, the cavities have a depth of about 20% to about 80% or about 30% to about 70% of the average thickness of the foam layer. In particular embodiments, the cavities formed in the foam layer have a depth of about 0.25 cm to about 20 cm, about 0.5 cm to about 18 cm, about 1 to about 18 cm, about 2 cm to about 17 cm, about 3 cm to about 16 cm, and about 5 cm to about 15 cm. Moreover, the depth of the cavities can vary on the same foam layer. For instance, a foam layer could comprise two or more cavities, each having different depths. Likewise, the foam layer could comprise a single cavity, wherein the depth of the cavity varies within the cavity.

The foam layer can still further be characterized by the percentage of the surface area of the foam layer encompassed by the cavities. In one embodiment, the cavities formed in the surface of the foam comprise about 1% to about 95% of the surface area of the foam layer. In further embodiments, the cavities comprise about 5% and about 95% of the surface area of the foam layer, about 10% to about 95%, about 15% to about 95%, about 20% to about 95%, about 25% to about 95%, about 30% to about 95%, or about 50% to about 95% of the surface area of the foam layer. In still further embodiments, the cavities comprise at least about 5%, at least about 10%, at least about 25%, at least about 50%, or at least about 75% of the surface area of the foam layer.

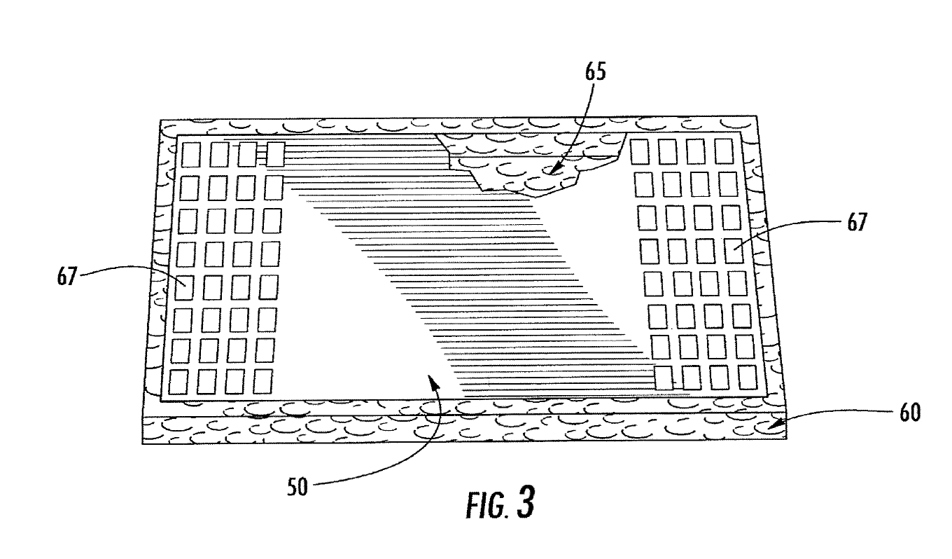

Another embodiment of a support apparatus prepared according to this method of the invention is illustrated in FIG. 3. As shown therein, a foam layer 60 is used as a mold and has a cavity 65 formed therein (revealed in the cut away portion of the gel layer) to receive the gel layer 50. As seen in this embodiment, the gel layer 50 can encompass a significant percentage of the surface of the foam layer 60. The foam layer 60 further comprises a series of raised portions 67 formed near the ends of the foam layer 60 wherein the foam material has only been partially removed (i.e., being covered with only a thin layer of gel) or has not been removed at all (as in the embodiment of FIG. 3). This further illustrates the highly customizable nature of the invention in the ability to prepare a variety of apparatus conformations of the gel layer and the foam layer merely by altering the cavity formation in the foam layer.

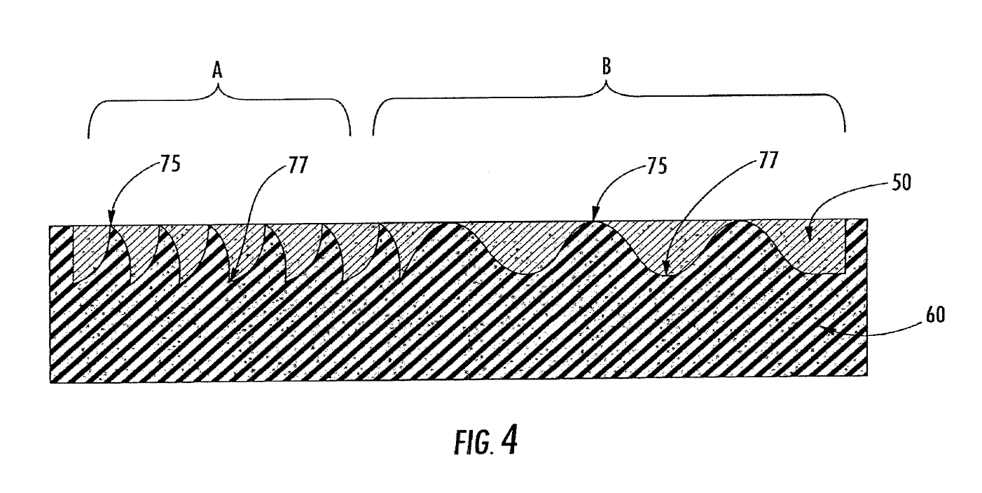

In another embodiment of the invention, the foam layer can be convoluted. A support apparatus prepared according to one method of the invention using convoluted foam is illustrated in FIG. 4, which provides a cross-sectional view of the apparatus. As seen therein, the surface of the foam layer 60 is convoluted, thereby providing a plurality of recesses for receiving the gel material. By convoluted is intended to mean that the surface of the foam has been shaped to have a pattern, generally a repeating pattern, wherein the surface is characterized by having ridges 75 and recesses 77, as illustrated in FIG. 4. In some embodiments, convoluted can further mean that the foam is patterned such that at least a portion of the foam folds back upon itself.

Convoluted foam for use in the present invention can be prepared in a variety of process, such as would be recognizable to the skilled artisan. Accordingly, the convoluted surface of the foam layer can take on a variety of conformations. For example, in FIG. 4, portion A of the foam is shown having crest, or fin-like ridges 75 with relatively narrow recesses 77 between the ridges 75. Alternatively, portion B of the foam illustrates more of a sinusoidal wave-like pattern, wherein the ridges 75 are more widely spaced by the recesses 77. Of course, as previously noted, these embodiments are only illustrative of the various convoluted surfaces that could be formed in the foam layer.

The gel layer 50 in FIG. 4 is shown as filling the area between the ridges of the convoluted foam layer 60. In further embodiments, the gel material can be applied to the foam layer 60 in an amount such that the gel layer 50 only partially fills the area between the ridges 75 of the foam layer 60. Moreover, the gel material could be applied in an amount such that the gel layer completely fills the area between the ridges 75 of the foam layer 60 and further rises above the ridges 75.

In one embodiment, a method comprises providing a foam layer comprising a foam piece having a surface that is at least partially convoluted and applying a gel material to the convoluted surface of the foam layer to form a gel layer thereon. A method can further comprise affixing a cover layer (such as a second foam layer) to the gel layer. Optionally, the gel layer can be at least partially cured prior to affixing the cover layer to the gel layer.

As previously described herein, the support apparatus prepared according to a method of the present invention generally comprises a gel layer and a second layer, such as a cover layer. In specific embodiments, the cover layer comprises a foam layer. In further embodiments, the apparatus comprises a foam layer, a gel layer, and optional further layers, particularly a cover layer. When the apparatus comprises a foam layer and a gel layer, the cover layer can be applied to the gel layer, or to the apparatus overall. Likewise, when the apparatus comprises a gel layer and a cover layer, the cover layer can be capable of covering only a top surface of the gel layer or completely surrounding the gel layer. Moreover, the apparatus can comprise a gel layer, a cover layer (such as a foam layer), and a further cover layer.

The cover layer can generally comprise any type of material commonly used in coverings for the various types of support apparatuses encompassed by the invention. Such coverings include natural and synthetic materials. Further, such coverings can also include padding. For example, when the support apparatus is a mattress, the covering can be a padded mattress topper. Further, any type of upholstering material can be used as the cover in the present invention. Accordingly, the presence of the gel layer in no way limits the types of covers available for use in covering the support apparatus prepared according to the methods of the invention. Furthermore, other types of coverings are also encompassed by the invention. For example, the covering can comprise a film, such as a polyurethane film, a coating, such as a polymer that is non-reactive or non-tacky in a dried or cured state, or a foam. Additionally, the cover layer can include texturing, thereby providing a three-dimensional effect to the cover layer.

As noted above, the apparatus prepared according to the invention can be customized through management of shaping or cavity formation in the foam layer. For example, different levels of support and comfort can be achieved through varying combinations of gel surface area, cavity shape, cavity placement, and cavity depth. Most generally, the foam layer can comprise a single cavity covering only a small percentage or almost all of the surface area of the foam layer. The foam layer can also comprise a complex pattern of cavities formed across the surface of the foam layer. Moreover, the cavities can beneficially be positioned for strategic and therapeutic benefits. For example, in one embodiment, wherein a method of the invention comprises preparation of a mattress, the cavities formed in the foam layer can be arranged in one or more areas of the foam layer corresponding to a particular body part of a potential user of the mattress. In particular, the cavity may correspond to trunk area of a user to allow for beneficial contouring of the gel layer to the body (particularly the back) of the user.

This method of the invention is particularly adaptable for continuous manufacturing processes. For example, a single foam piece could be carried along a process line. At one station, the appropriate cavities could be formed, at a station down the line, the gel could be inserted into the cavities, at yet another station, optional further layers could be applied to the gel layer, and at still another station the individual apparatuses could be cut free from the continuous foam. Similar manufacturing methods could be particularly adapted to methods incorporating convoluted foam layers.

The present invention can further be adapted to “stop-and-go” manufacturing according to certain methods encompassed by the invention. For instance, a method can comprise the use of a conventional mold, wherein the components of the apparatus to be prepared are place in the mold, allowed to cure or foam, and then removed from the mold after a suitable amount of time.

As previously noted, the foam material used in a method of the invention can comprise any type of foam material generally recognized as useful in the field. For example, in certain embodiments, polyurethane foams are particularly preferred. However, other foams could also be used. For instance, latex foams could also be used according to the invention.

In another embodiment, the invention generally comprises preparing a support apparatus according to a method comprising the following steps: preparing a gel layer comprising a first surface and an opposing surface and having a release layer affixed to at least one of the surfaces; preparing a foam layer having a surface adapted for receiving at least a portion of the gel layer; and affixing the gel layer to the foam layer. As previously noted, the affixing step can comprise various methods, such as gluing, stitching, welding, and combinations thereof. Accordingly, it is possible, according to the invention, to prepare various components of the support apparatus separately and then combine the individual components into a completed apparatus.

Many modifications and other embodiments of the inventions set forth herein will come to mind to one skilled in the art to which these inventions pertain having the benefit of the teaching presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for preparing a mattress comprising a gel layer, said method comprising:
providing a mold;
optionally placing a release layer in the mold;
providing a gel material that is a polyurethane gel;
inserting the gel material into the mold, thereby forming a gel layer;
wherein the gel layer faces a user;
optionally, at least partially curing the gel layer; and
affixing a cover layer to the gel layer,
wherein the gel material has a hardness in the range of 4.5 kPa±1.5 kPa when measured according to the method of ISO 3386-1, and wherein the gel material exhibits a hysteresis of 40%±10%.

2. The method according to claim 1, wherein the release layer is placed in
the mold and comprises a material selected from the group consisting of a polymer film, a textile layer, a liquid coating layer, a waxy layer, and a powder layer.

3. The method according to claim 2, wherein the release layer comprises a material having a free edge, and wherein the method further comprises affixing the free edge of the material to the gel layer.

4. The method according to claim 3, wherein said step of affixing the free edge of the material to the gel layer comprises a method selected from the group consisting of gluing, stitching, and welding.

5. The method according to claim 1, wherein the step of providing a polyurethane gel is obtained by providing a gel material comprising a composition of:
(a) a high molecular weight covalently cross-linked polyurethane matrix at 15 to 62 weight % or 20 to 57 weight % or 25 to 47 weight %, relative to the sum of components (a) and (b);
(b) a liquid dispersing agent which is firmly bonded in the matrix by secondary valence forces at 85 to 38 weight % or 80 to 43 weight % or 75 to 53 weight %, relative to the sum of components (a) and (b); and
(c) one or more other additives at 0 to 100 weight %, relative to the sum of components (a) and (b);
wherein the gel material has an isocyanate number in the range of 15 to 60 or 20 to 55 or 25 to 45, and the isocyanate and hydroxyl compounds forming the polyurethane are both poly-functional;
mixing said components (a), (b) and (c);
reacting said components (a), (b) and (c).

6. The method according to claim 5, wherein the liquid dispersing agent of component (b) is one or more polyhydroxy compound having an average molecular weight between 1,000 and 12,000 or between 1,700 and 6,000 and an OH number between 20 and 112 or between 28 and 84 or between 30 and 56, wherein the dispersing agent does not contain hydroxy compounds with a molecular weight below 1,000 or below 800.

7. The method according to claim 5, wherein, the polyurethane matrix is prepared by reacting isocyanate and polyol compounds and in the preparation of the polyurethane matrix, the product of the isocyanate functionality and the polyol functionality is at least 5.2 or at least 6.2 or at least 8 or at least 10 or 12.

8. The method according to claim 1, comprising the step of providing the gel layer having the surface facing the user that is smooth or that comprises a plurality of small towers that arise from a planar surface thereof or that comprises small towers separated the one from the other by channels free of material that allow a free circulation of air.

9. The method according to claim 1, wherein said step of affixing the cover layer to the gel layer comprises a method selected from the group consisting of gluing, stitching, and welding.

10. The method of claim 1, wherein said cover layer comprises a material selected from the group consisting of a foam layer, a polymer film, a textile layer, a liquid coating layer, a waxy layer, and a powder coating layer.

11. The method according to claim 1, wherein the mold comprises a vacuum-assist mold.

12. The method according to claim 1, wherein the mold comprises one or more layers of a support material having one or more cavities formed therein for receiving the gel material.

13. The method according to claim 12, wherein the mold comprises a foam layer comprising a foam piece having a defined average thickness and having a surface with one or more cavities formed therein.

14. The method according to claim 13, wherein the one or more cavities encompass an area comprising about 1% to about 95% of the surface of the foam piece.

15. The method according to claim 13, wherein the one or more cavities are in an area corresponding to a specific area of the body of a potential user of the mattress.

16. The method according to claim 13, wherein the one or more cavities are arranged in a specific pattern across the surface of the foam piece.

17. The method according to claim 13, wherein the one or more cavities have a depth of about 10% to about 90% of the average thickness of the foam layer.

18. The method according to claim 12, wherein the mold comprises a textile layer having one or more cavities formed therein.

19. The method according to claim 12, wherein the mold comprises a sandwich textile comprising a foam layer between a first textile layer and a second textile layer, said foam layer having one or more cavities formed therein.

20. The method according to claim 1, further comprising combining at least the gel layer and the cover layer with one or more additional layers selected from the group consisting of a foam layer, a spring layer, a textile layer, a gas layer, a wood layer, a metal layer, a plastic layer, and combinations thereof.

21. The method according to claim 1, wherein the mold comprises a foam piece with a surface that is at least partially convoluted.

22. A method for preparing a mattress comprising a gel layer and a foam layer, said method comprising:
providing a gel material that is a polyurethane gel;
preparing a gel layer comprising said gel material and having a top surface and a bottom surface and having a release layer affixed to at least one of said top surface and said bottom surface, wherein the gel layer faces a user;
preparing a foam layer having a surface adapted for receiving at least a portion of said gel layer; and
affixing said gel layer to said foam layer by a method selected from the group consisting to gluing, stitching, welding, and combinations thereof,
wherein the gel material has a hardness in the range of 4.5 kPa±1.5 kPa when measured according to the method of ISO 3386-1, and wherein the gel material exhibits a hysteresis of 40%±10%.

23. The method according to claim 22, wherein the step of providing a polyurethane gel is obtained by providing a gel material comprising a composition of
(a) a high molecular weight covalently cross-linked polyurethane matrix at 15 to 62 weight % or 20 to 57 weight % or 25 to 47 weight %, relative to the sum of components (a) and (b);
(b) a liquid dispersing agent which is firmly bonded in the matrix by secondary valence forces at 85 to 38 weight % or 80 to 43 weight % or 75 to 53 weight %, relative to the sum of components (a) and (b); and
(c) one or more other additives at 0 to 100 weight %, relative to the sum of components (a) and (b);
wherein the gel material has an isocyanate number in the range of 15 to 60 or 20 to 55 or 25 to 45, and the isocyanate and hydroxyl compounds forming the polyurethane are both poly-functional;
mixing said components (a), (b) and (c);
reacting said components (a), (b) and (c).

24. The method according to claim 23, wherein the liquid dispersing agent of component (b) is one or more polyhydroxy compound having an average molecular weight between 1,000 and 12,000 or between 1,700 and 6,000 and an OH number between 20 and 112 or between 28 and 84 or between 30 and 56, wherein the dispersing agent does not contain hydroxy compounds with a molecular weight below 1,000 or below 800.

25. The method according to claim 23, wherein, the polyurethane matrix is prepared by reacting isocyanate and polyol compounds and in the preparation of the polyurethane matrix, the product of the isocyanate functionality and the polyol functionality is at least 5.2 or at least 6.2 or at least 8 or at least 10 or 12.

26. The method according to claim 23, comprising the step of providing the gel layer having the surface facing the user that is smooth or that comprises a plurality of small towers that arise from a planar surface thereof or that comprises small towers separated the one from the other by channels free of material that allow a free circulation of air.
